(19) United States
(12) Patent Application Publication
(10) Pub. No.: US 2023/0227329 A1
(43) Pub. Date: Jul. 20, 2023

(54) WATER FILTER CARTRIDGE HAVING ULTRAVIOLET STERILIZING FUNCTION AND WATER PURIFIER USING THE SAME

(71) Applicant: HARVATEK CORPORATION, Hsinchu City (TW)

(72) Inventors: Hsin-I Lu, HSINCHU COUNTY (TW); YU-CHANG HU, Hsinchu City (TW); SHYI-MING PAN, Miaoli County (TW); FENG-HUI CHUANG, New Taipei City (TW)

(21) Appl. No.: 17/870,841

(22) Filed: Jul. 22, 2022

(30) Foreign Application Priority Data
Jan. 14, 2022 (TW) 111101594

(51) Int. Cl. C02F 1/00; C02F 1/32; C02F 1/28; C02F 1/42

(52) U.S. Cl. CPC C02F 1/003; C02F 1/325; C02F 1/283; C02F 1/42; C02F 2307/04; C02F 2303/04; C02F 2201/009; C02F 2201/3222; C02F 2201/328; C02F 2201/326

(57) ABSTRACT

A water filter cartridge having an ultraviolet sterilizing function and a water purifier are provided. The water filter cartridge includes a housing, a filtering component, a plurality of flow channels, and an ultraviolet module. The housing has an upper chamber and a lower chamber in fluid communication with the upper chamber. The filtering component is disposed in the upper chamber. The flow channels are arranged in the lower chamber and stacked in a multi-layered arrangement. The ultraviolet module includes an ultraviolet light emitting element disposed in the lower chamber.

### CROSS-REFERENCE TO RELATED PATENT APPLICATION

This application claims the benefit of priority to Taiwan Patent Application No. 111101594, filed on Jan. 14, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a water filter cartridge, and more particularly to a water filter cartridge having an ultraviolet sterilizing function and a water purifier using the same.

### BACKGROUND OF THE DISCLOSURE

The scarcity of water resources has become an increasingly serious problem. Less than 1% of all the water on earth is freshwater that we can actually use. Therefore, water purification treatment has become a topic of global concern. It is well known that tap water undergoing a series of purification treatments in water plants has a lot of chemical residues therein and is transported from the water plants to each household through several kilometers of tap water pipes. As a result, water pollution of the tap water may be aggravated, such that many bacteria, residual chlorine, calcium and magnesium ions and other harmful substances ultimately reside in the tap water, causing the tap water to be unsuitable for being drunk directly.

There are a variety of tap water purification devices on the market to ensure that the water to be drunk reaches drinkable standards. However, these purification devices generally have a large volume and weight, require a complicated installation procedure, have difficult-to-replace filter cartridges, and are not portable, rendering them unsuitable for ordinary families and outdoor activities. Therefore, portable water filter jugs have a filter cartridge for direct filtration of tap water introduced therein, and can store filtered water for drinking. Nowadays, portable water filter jugs are becoming more and more popularized among workplaces and households alike, offering a new alternative to purification devices in providing healthy drinking water.

In order to remove pathogenic bacteria such as Escherichia coli, Salmonella, and mold, a new generation of water filter jugs incorporate a high-power UV (ultraviolet) lamp that is installed outside a filter cartridge. However, such a design is harmful to human health due to the following reasons: the human body may be irradiated with ultraviolet light, and ultraviolet light is destructive to a plastic jug body, the latter of which eventually causes the decomposition of a plasticizer from the plastic jug body after irradiation, resulting in the plasticizer being dissolved into water. Compared to the UV lamp, a UV LED (light emitting diode) has the characteristics of long service life, low energy consumption, and small volume, and is generally a better choice than the UV lamp. Therefore, one of the directions of development in the industry is to ensure filtration and sterilization effects of the water filter jug by applying a UV LED thereto in cooperation with a filter cartridge, so as to produce cleaner water.

### SUMMARY OF THE DISCLOSURE

In response to the above-referenced technical inadequacies, the present disclosure provides a water filter cartridge having an ultraviolet sterilizing function, which can be used with no concerns about exposure of the human body to ultraviolet light and release of a plasticizer. The present disclosure further provides a water purifier using the water filter cartridge.

In one aspect, the present disclosure provides a water filter cartridge having an ultraviolet sterilizing function, which includes a housing, a filtering component, a plurality of flow channels, and an ultraviolet module. The housing has an upper chamber and a lower chamber in fluid communication with the upper chamber, and the upper chamber is configured to introduce raw water to the lower chamber. The filtering component is disposed in the upper chamber to filter the raw water, so as to produce filtered water. The flow channels are arranged in the lower chamber and stacked in a multi-layered arrangement, so as to guide the filtered water to an outside of the lower chamber. The ultraviolet module includes an ultraviolet light emitting element disposed in the lower chamber, so as to generate ultraviolet light for irradiating the filtered water.

In certain embodiments, the water filter cartridge further includes a plurality of partitioning boards that are disposed in the lower chamber and spaced apart from each other along an up-down direction. The flow channels are separated from each other by the partitioning boards, and each of the partitioning boards has a flow hole.

In certain embodiments, the flow holes of two adjacent ones of the partitioning boards are staggered with respect to each other in a long axis direction of the lower chamber.

In certain embodiments, the flow channels include a first flow channel at an upper position and a second flow channel at a lower position. The first flow channel defines a first water flow direction, and the second flow channel defines a second water flow direction that is opposite to the first water flow direction.

In certain embodiments, an inner wall of the housing has a plurality of retaining grooves that are arranged at intervals to respectively fix the partitioning boards in position.

In certain embodiments, the ultraviolet module is disposed in a lowermost one of the flow channels.

In certain embodiments, a lowermost one of the partitioning boards separates a closed waterproof space from a lowermost one of the flow channels, and the ultraviolet module is disposed in the closed waterproof space.

In certain embodiments, the ultraviolet module further includes a circuit board, a power source, and a control element, and the ultraviolet light emitting element, the power source, and the control element are disposed on one surface of the circuit board.

In certain embodiments, the ultraviolet module further includes a coil structure disposed on another surface of the circuit board being opposite to the one surface thereof.

In certain embodiments, the water filter cartridge further includes a switch module. The switch module includes two conductors that are disposed in an uppermost one of the flow channels and spaced apart from each other. The switch module is configured to trigger the control element to drive the ultraviolet light emitting element to generate ultraviolet light when the filtered water provides electrical conduction between the two conductors.

In certain embodiments, the filtering component includes a filter screen layer, an activated carbon layer, an ion-exchange resin layer, and a filtering cotton layer arranged sequentially from top to bottom.

In another aspect, the present disclosure provides a water purifier, which includes a water storage container and a water filter cartridge having an ultraviolet sterilizing function as mentioned above, and the water filter cartridge is disposed in the water storage container.

Therefore, in the water filter cartridge having the ultraviolet sterilizing function of the present disclosure, in which the lower chamber of the housing has a plurality of flow channels stacked in a multi-layered arrangement and the ultraviolet module includes an ultraviolet light emitting element disposed in the lower chamber, the flow distance of filtered water can be increased so as to achieve a sufficient sterilization effect of ultraviolet light. Furthermore, ultraviolet light is only irradiated inside the filter cartridge and will not leak out to the outside and cause harm to the human body. In addition, the water filter cartridge having the ultraviolet sterilizing function of the present disclosure can be replaced frequently, and the housing thereof can be discarded before any deterioration has taken place, so as to prevent a plasticizer from entering the human body together with clean water. Therefore, safe clean water can be provided anytime and anywhere.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a water filter cartridge having an ultraviolet sterilizing function of the present disclosure;

FIG. 2 is a schematic perspective cross-sectional view of the water filter cartridge having the ultraviolet sterilizing function of the present disclosure;

FIG. 3 is a schematic cross-sectional view taken along line III-III of FIG. 1;

FIG. 4 is a schematic view showing a use state of the water filter cartridge having the ultraviolet sterilizing function of the present disclosure;

FIG. 5 is a schematic partial perspective view of the water filter cartridge having the ultraviolet sterilizing function of the present disclosure; and

FIG. 6 is a schematic perspective view of a water purifier of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

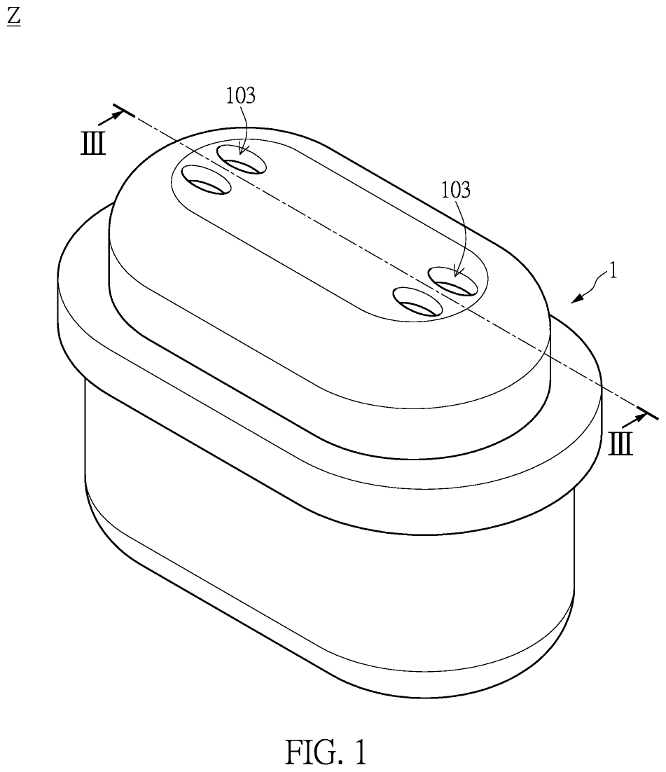

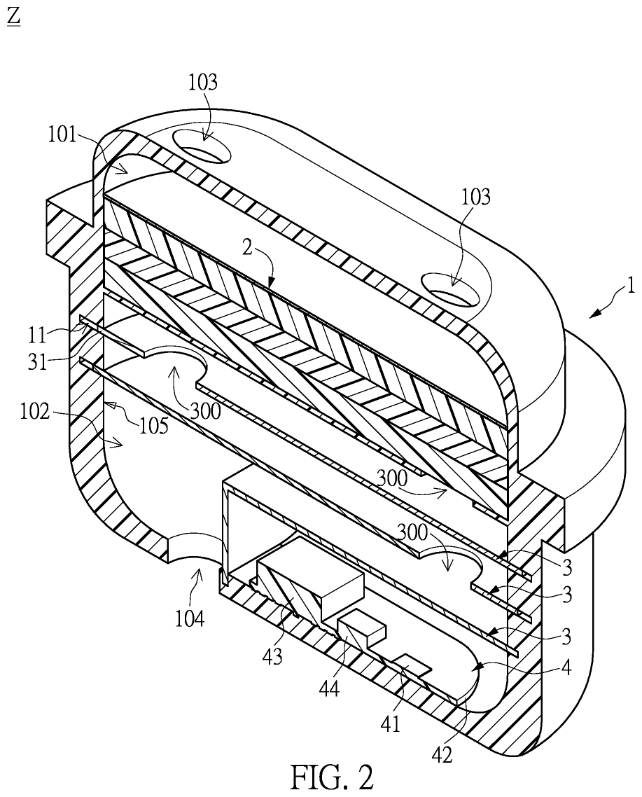

Referring to FIG. 1 to FIG. 5, embodiments of the present disclosure provide a water filter cartridge Z having an ultraviolet sterilizing function, which includes a housing 1, a filtering component 2, a plurality of flow channels F, and an ultraviolet module 4. The housing 1 has an upper chamber 101 and a lower chamber 102 in fluid communication with the upper chamber 101. The filtering component 2 is disposed in the upper chamber 101. The flow channels F are arranged in the lower chamber 102 and stacked in a multi-layered arrangement (i.e., spaced apart from each other along an up-down direction). The ultraviolet module 4 includes an ultraviolet light emitting element 41 disposed in the lower chamber 102.

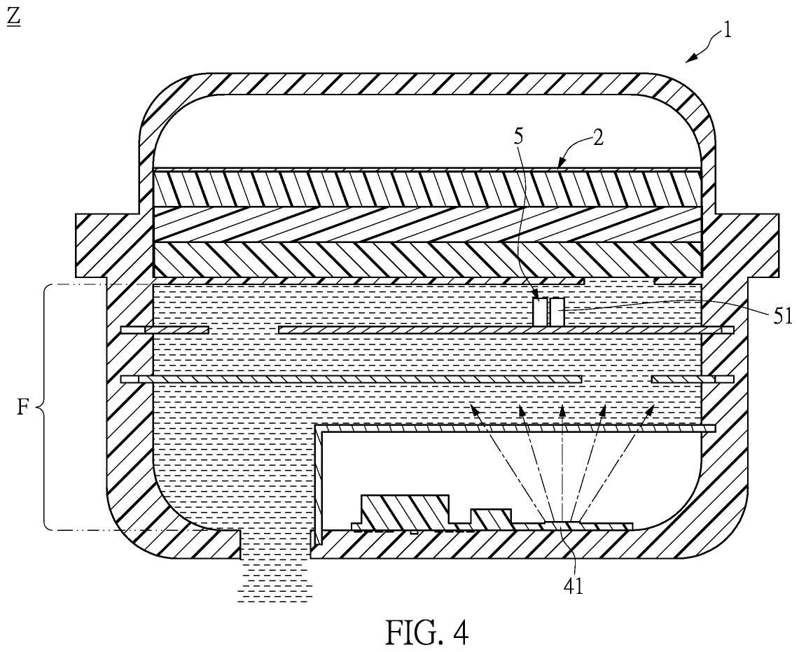

In use, raw water (e.g., tap water) can be introduced into the upper chamber 101 to be filtered by the filtering component 2, and filtered water can flow out of the lower chamber 102 through the flow channels F, while the ultraviolet light emitting element 41 generates ultraviolet light to irradiate and sterilize the filtered water, as shown in FIG. 4. It is worth mentioning that when a flow of the filtered water is guided to the outside of the lower chamber 102 through the flow channels F stacked in the multi-layered arrangement, the flow distance thereof would be increased so as to achieve a sufficient sterilization effect of ultraviolet light. The ultraviolet light emitting element 41 can be an ultraviolet light emitting diode (UVC LED) chip or a package structure including one or more UVC LEDs to emit light at a wavelength between 200 nm and 280 nm, but the present disclosure is not limited thereto.

In the present embodiment, a top portion of the housing 1 can have one or more water inlet holes 103 that are in fluid communication with the upper chamber 101, and a bottom portion of the housing 1 can have one or more water outlet holes 104 that are in fluid communication with the lower chamber 102. Accordingly, raw water can be introduced into the upper chamber 101 through the water inlet holes 103 and flows into the filtering component 2 by gravity for multi-layer filtration, thereby obtaining filtered water having better water quality. Afterwards, the filtered water is irradiated with ultraviolet radiation and flows out of the lower chamber 102 along a meandering flow path established by the flow channels F, thereby obtaining clean water that is safe for the human body and can be drunk directly. The flow channels F can include a first flow channel F1 at an upper position and a second flow channel F2 at a lower position, the first flow channel F1 defines a first water flow direction F1d, and the second flow channel F2 defines a second water flow direction F2d that is opposite to the first water flow direction F1d.

In practice, the housing 1 can be made of a plastic material, and the shape thereof can be changed according to particular requirements. For example, the housing 1 can be designed to have a box-like shape that is convenient for installation and replacement. The filtering component 2 can include a filter screen layer 21, an activated carbon layer 22, an ion-exchange resin layer 23, and a filtering cotton layer 24 arranged sequentially from top to bottom, but the present disclosure is not limited thereto.

More specifically, as shown in FIG. 1 to FIG. 3, the water filter cartridge Z having the ultraviolet sterilizing function includes a plurality of partitioning boards 3 that are disposed in the lower chamber 102 and spaced apart from each other along an up-down direction, and the flow channels F are separated from each other by the partitioning boards 3. Each of the partitioning boards 3 has a flow hole 300, such that the flow channels F can be in fluid communication with each other. Furthermore, an inner wall 105 of the housing 1 has a plurality of retaining grooves 11 that are disposed at intervals in the lower chamber 102 to respectively fix the partitioning boards 3 in position. The retaining grooves 11 are recessed from the inner wall 105 of the housing 1, and an edge portion 31 of each of the partitioning boards 3 is engaged in the corresponding retaining groove 11, in which the edge portion 31 and the corresponding retaining groove 11 complement each other in shape. It is worth mentioning that the partitioning boards 3 are permeable to ultraviolet light and do not affect the sterilization effect of the ultraviolet light. Preferably, the flow holes 300 of two adjacent ones of the partitioning boards 3 are staggered with respect to each other in a long axis direction of the lower chamber 102. Accordingly, a flow path length of each of the flow channels F can be increased, so that the filtered water can be irradiated with ultraviolet light for enough time.

In practice, the partitioning boards 3 can be made of glass or a plastic material. An uppermost one of the partitioning boards 3 can be transparent or opaque, and the rest of the partitioning boards 3 can be transparent. Furthermore, the uppermost one of the partitioning boards 3 can be used to divide the interior of the housing 1 into the upper chamber 101 and the lower chamber 102 and to carry and support the filtering component 2. A lowermost one of the partitioning boards 3 can be used to separate a closed waterproof space from a lowermost one of the flow channels F, and the ultraviolet module 4 is disposed in the closed waterproof space to be kept away from water. The above description is for exemplary purposes only and is not intended to limit the scope of the present disclosure. In an embodiment not shown in the above figures, the ultraviolet module 4 can be subjected to waterproof treatment. For example, the ultraviolet light emitting element 41 can be sealed in a package to be directly disposed in the lowermost flow channel F.

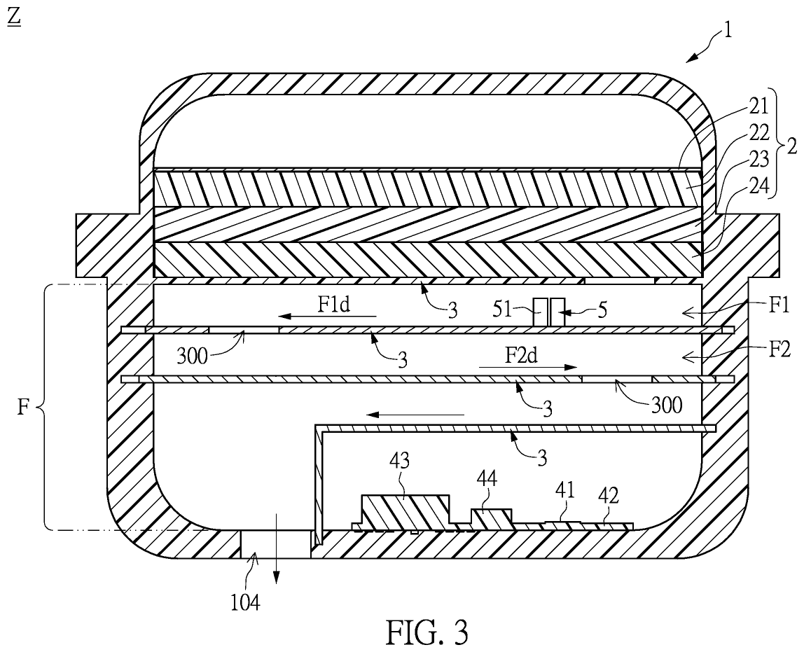

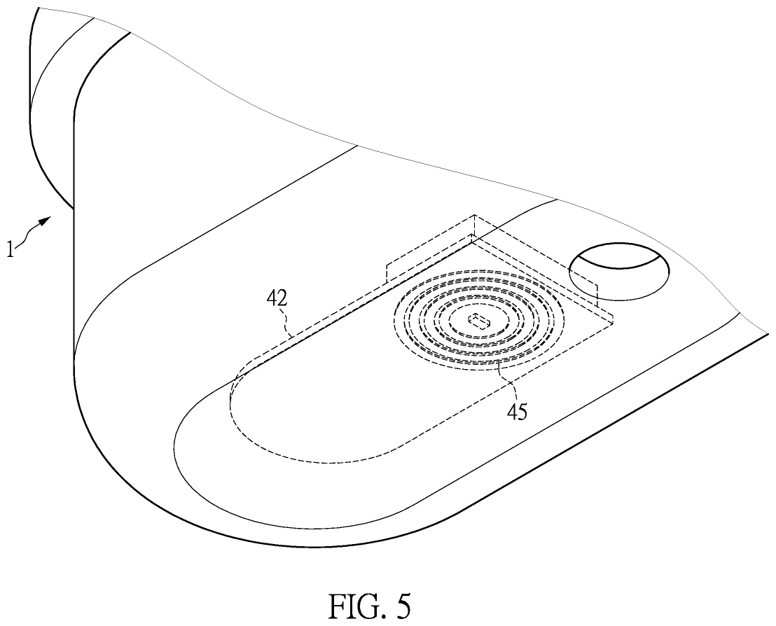

As shown in FIG. 3, the ultraviolet module 4 further includes a circuit board 42, a power source 43, and a control element 44 so as to improve practicability. The ultraviolet light emitting element 41, the power source 43, and the control element 44 are all disposed on one surface of the circuit board 42 facing the flow channels F and electrically connected to the circuit board 42. The power source 43 can supply power required for the ultraviolet module 4 and is preferably a rechargeable battery, so that there is no need for external connections to a power supply. The control element 44 can drive the ultraviolet light emitting element 41 to generate ultraviolet light, and can be a programmable control chip or a circuit. In a structure using a rechargeable battery as the power source 43, the ultraviolet module 4 can include a coil structure 45 disposed on another surface of the circuit board 42 being opposite to the one surface thereof, as shown in FIG. 5. The coil structure 45 can include a wireless charging coil. Therefore, when the water filter cartridge Z having the ultraviolet sterilizing function or a device provided with the same is placed on a wireless charger (not shown in the above figures), the rechargeable battery serving as the power source 43 can be charged.

According to particular requirements, the coil structure 45 can further include a near-field induction coil to record the condition of use of the filter by an NFC read-write function, so as to remind the user that the filter cartridge needs a replacement. A reminder can be provided by displaying a relevant message on a display window or lighting an indicator light. Therefore, the deterioration of water quality due to the use of the filter that has expired can be avoided.

As shown in FIG. 3 and FIG. 4, the water filter cartridge Z having the ultraviolet sterilizing function can include a switch module 5 so as to save power. The switch module 5 can include two conductors 51 (e.g., two metal plates) that are disposed in the uppermost flow channel F and spaced apart from each other and a detection circuit (not shown in the above figures) is buried in the housing 1. The power source 43 is electrically connected to the control element 44 via the two conductors 51. When no water flows through the uppermost flow channel F, there is no electrical conduction between the two conductors 51 and the detection circuit is open. When filtered water flows through the uppermost flow channel F (i.e., the flow channel at the first layer), electrical conduction can be established between the two conductors 51. As a result, the power supply 43 can provide a voltage to trigger the control element 44, so that the control element 44 can drive the ultraviolet light emitting element 41 to generate ultraviolet light.

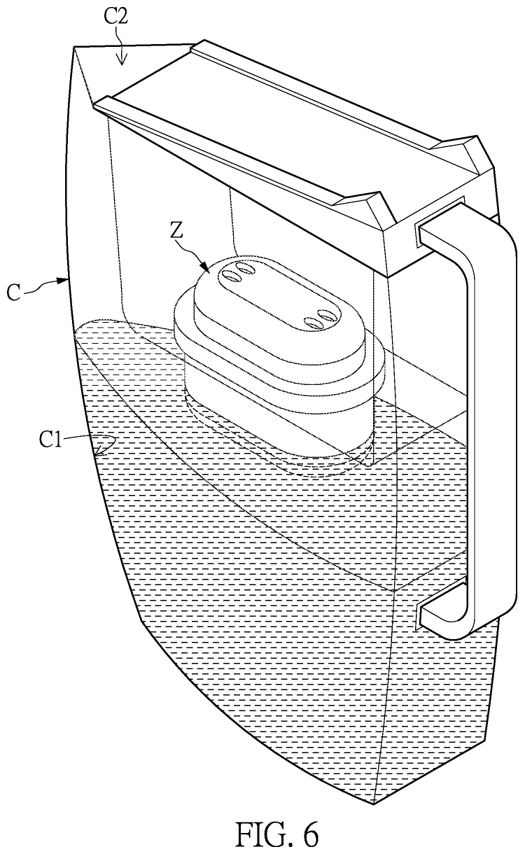

Referring to FIG. 6, which is to be read in conjunction with FIG. 1 to FIG. 4, embodiments of the present disclosure provide a water purifier, which includes a water storage container C and the above-mentioned water filter cartridge Z having the ultraviolet sterilizing function. The water filter cartridge Z is installed inside the water storage container C to filter and sterilize raw water introduced into the water storage container C, thereby obtaining clean water that is safe for the human body and is stored in a water storage space C1 located below the water filter cartridge Z. In use, the water storage container C can be tilted to allow the clean water to flow out of the water storage space C1 from a water outlet C2 for drinking.

Although the water filter cartridge Z having the ultraviolet sterilizing function of the present disclosure is, for example, applied to a water filter cartridge kettle as shown in FIG. 6, it can be applied to other forms of water purifiers, such as a water purifier placed on a kitchen countertop or under a kitchen sink and a wall-mounted water purifier.

### Beneficial Effects of the Embodiments

In the water filter cartridge having the ultraviolet sterilizing function of the present disclosure, in which the lower chamber of the housing has a plurality of flow channels stacked in a multi-layered arrangement and the ultraviolet module includes an ultraviolet light emitting element disposed in the lower chamber, the flow distance of filtered water can be increased so as to achieve a sufficient sterilization effect of ultraviolet light. Furthermore, ultraviolet light is only irradiated inside the filter cartridge and will not leak out to the outside and cause harm to the human body. In addition, the water filter cartridge having the ultraviolet sterilizing function of the present disclosure can be replaced frequently, and the housing thereof can be discarded before any deterioration has taken place, so as to prevent a plasticizer from entering the human body together with clean water. Therefore, safe clean water can be provided anytime and anywhere.

More specifically, the ultraviolet light emitting element can be integrated with the circuit board, the power source, and the control element into a module (modularization), which is beneficial to reduce the volume of the filter and save an installation space. Furthermore, in the module, a rechargeable battery can be used as the power source, so that there is no need for external connections to a power supply. The circuit board can be provided with a wireless charging coil, so that the rechargeable battery can be charged. In addition, the circuit board can be further provided with a near-field induction coil to record the condition of use of the filter by an NFC read-write function, so as to remind the user that the filter needs a replacement. Therefore, the deterioration of water quality due to the use of the filter that has expired can be avoided.

More specifically, the water filter cartridge having the ultraviolet sterilizing function can include a switch module, which is configured to trigger the control element when filtered water flows through the uppermost flow channel to provide electrical conduction between two conductors spaced apart from each other, so that the control element can drive the ultraviolet light emitting element to generate ultraviolet light, thereby saving power.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A water filter cartridge having an ultraviolet sterilizing function, comprising:
a housing having an upper chamber and a lower chamber in fluid communication with the upper chamber, the upper chamber being configured to introduce raw water to the lower chamber;
a filtering component disposed in the upper chamber to filter the raw water so as to produce filtered water;
a plurality of flow channels arranged in the lower chamber and stacked in a multi-layered arrangement, so as to guide the filtered water to an outside of the lower chamber; and
an ultraviolet module including an ultraviolet light emitting element disposed in the lower chamber, so as to generate ultraviolet light for irradiating the filtered water.

2. The water filter cartridge according to claim 1, further comprising a plurality of partitioning boards that are disposed in the lower chamber and spaced apart from each other along an up-down direction, wherein the flow channels are separated from each other by the partitioning boards, and each of the partitioning boards has a flow hole.

3. The water filter cartridge according to claim 2, wherein the flow holes of two adjacent ones of the partitioning boards are staggered with respect to each other in a long axis direction of the lower chamber.

4. The water filter cartridge according to claim 3, wherein the flow channels include a first flow channel at an upper position and a second flow channel at a lower position, the first flow channel defines a first water flow direction, and the second flow channel defines a second water flow direction that is opposite to the first water flow direction.

5. The water filter cartridge according to claim 2, wherein an inner wall of the housing has a plurality of retaining grooves that are arranged at intervals to respectively fix the partitioning boards in position.

6. The water filter cartridge according to claim 2, wherein the ultraviolet module is disposed in a lowermost one of the flow channels.

7. The water filter cartridge according to claim 6, wherein the ultraviolet module further includes a circuit board, a power source, and a control element, and the ultraviolet light emitting element, the power source, and the control element are disposed on a surface of the circuit board.

8. The water filter cartridge according to claim 2, wherein a lowermost one of the partitioning boards separates a closed waterproof space from a lowermost one of the flow channels, and the ultraviolet module is disposed in the closed waterproof space.

9. The water filter cartridge according to claim 8, wherein the ultraviolet module further includes a circuit board, a power source, and a control element, and the ultraviolet light emitting element, the power source, and the control element are disposed on one surface of the circuit board.

10. The water filter cartridge according to claim 9, wherein the ultraviolet module further includes a coil structure disposed on another surface of the circuit board being opposite to the one surface thereof.

11. The water filter cartridge according to claim 9, further comprising a switch module, wherein the switch module includes two conductors that are disposed in an uppermost one of the flow channels and spaced apart from each other, and is configured to trigger the control element to drive the ultraviolet light emitting element to generate ultraviolet light when the filtered water provides electrical conduction between the two conductors.

12. The water filter cartridge according to claim 1, wherein the filtering component includes a filter screen layer, an activated carbon layer, an ion-exchange resin layer, and a filtering cotton layer arranged sequentially from top to bottom.

13. A water purifier comprising a water storage container, and the water filter cartridge as claimed in claim 1 being disposed in the water storage container.
